(19) United States
(12) Patent Application Publication
(10) Pub. No.: US 2002/0129969 A1
(43) Pub. Date: Sep. 19, 2002

(54) Electrical cable

(75) Inventors: Ferdinand Groegl, Nuernberg (DE); Reingold Goeblmaier, Fuerth (DE); Thomas Mann, Weissenohe (DE)

Correspondence Address: SUGHRUE MION, PLLC, 2100 Pennsylvania Avenue, N.W., Washington, DC, 20037-3213, US

(73) Assignee: NEXANS

(21) Appl. No.: 10/046,079

(22) Filed: Jan. 16, 2002

(30) Foreign Application Priority Data
Jan. 16, 2001 (DE) 10101641.7

(51) Int. Cl. H01B 5/08

(52) U.S. Cl. 174/128.1

(57) ABSTRACT

In an electrical cable, particularly a sensor cable, with an electrical conductor (1a, 2a) and an insulating layer (1b, 2b) surrounding the conductor, the conductor (1a, 2a) is made of a plurality of stranded or bunched wire bundles (4). Each wire bundle (4) has a central core wire (5) that is made of a metal with high tensile strength and alternating bending strength and a plurality of copper wires (6) that are stranded around the core wire (5).

This application is based on and claims the benefit of German Patent Application No. 10101641.7 filed Jan. 16, 2001, which is incorporated by reference herein.

### BACKGROUND OF THE INVENTION

The present invention relates to an electrical cable with an electrical conductor and an insulating layer surrounding the conductor.

Electrical cables to connect mobile power consumers must be flexible and have a finely or even a very finely stranded conductor, depending on the required flexibility.

For mechanical stressability and flexibility not only the quality and the diameter of the wires are important but particularly also the stranding structure of the conductor. The shorter the lay of the litz wires and the strands, the greater the flexibility and the alternating bending strength.

German Application DE-A-25 19 687 discloses a method for producing a stranded conductor in which a thread of glass-filament yarn is included in the stranding of a plurality of individual wires. This thread of glass-filament yarn is intended to compensate the adverse effects on the mechanical properties of the copper wires that occur during strong bunched stranding and at high production speeds. The tensile strength of glass-filament yarn is about five times that of a soft copper wire and the elongation at break is approximately 2% compared to an average elongation of 25% to 35% for copper wires. The thread of glass-filament yarn thus absorbs all the tensile parameters that occur during the production of the litz wire and during subsequent practical use. A disadvantage of this solution, however, is that the electrically conductive cross section of the litz wire is reduced. The presence of a non-metallic element in the litz wire is also frequently unacceptable.

To increase the alternating bending strength in litz wires, it has also been proposed to use conductor wires that are made of a copper alloy, e.g., copper-cadmium, copper-silver or copper-tin alloys. These proposals, however, have been successful for only a limited number of cable types. Furthermore, they are substantially more costly or more difficult to produce than standard litz wire structures.

In another solution it was proposed to construct the litz wires in such a way that soft copper wires were stranded around a hard-drawn copper wire. This improved the tensile strength, the alternating bending strength as well as the characteristics of the strand during the crimping process. For extreme applications, however, these litz wires also failed to be convincing.

### SUMMARY OF THE INVENTION

The object of the present invention is to improve the known electrical cables in such a way that they have a substantially higher alternating bending strength compared to cables of the prior art, but are less costly to produce.

This object is attained by an electrical cable, particularly a sensor cable, with an electrical conductor and an insulating layer surrounding the conductor, wherein the conductor comprises a plurality of stranded or bunched wire bundles and each wire bundle comprises a central core wire made of a metal with high tensile strength and alternating bending strength and a plurality of copper wires stranded around the core wire.

In addition to the advantages resulting directly from this object, the cable according to the invention is furthermore distinguished by a tensile strength that is higher compared to cables made of copper-cadmium or copper-tin alloys. Its electrical conductivity is only marginally lower than that of a prior-art cable.

### BRIEF DESCRIPTION OF THE DRAWINGS

The invention will now be described in greater detail with reference to the exemplary embodiments, which are schematically depicted in FIGS. 1 and 2, wherein:

FIG. 1 shows a cross section through an electrical cable according to the present invention; and

FIG. 2 illustrates a multi-wire conductor employed in the cable of FIG. 1.

### DETAILED DESCRIPTION OF THE INVENTION

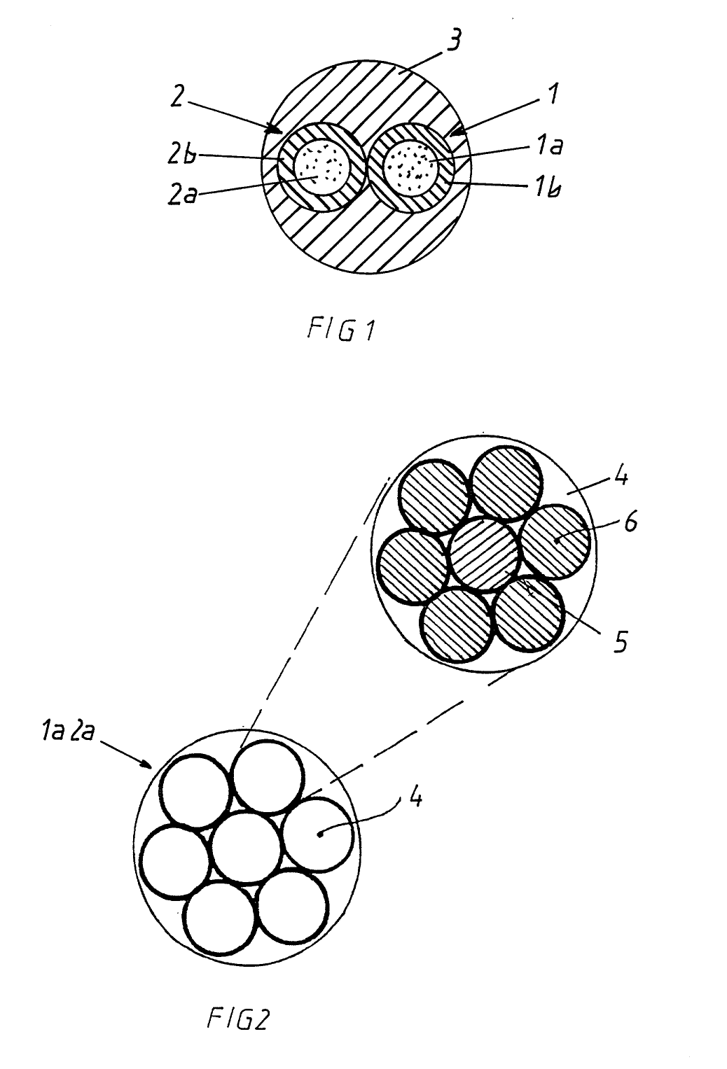

FIG. 1 is a cross section through an electrical cable, e.g., a sensor cable, comprising two strands 1 and 2 and a sheath 3 surrounding strands 1 and 2. Each strand comprises a conductor 1a or 2a and strand insulation 1b or 2b. The sheath 3 is preferably an extruded polyurethane sheath. The strand insulation 1a or 2b may be made of thermoplastic or cross-linked insulating materials. Preferred is irradiation cross linked polyethylene, polyurethane or a two-layer insulation, such as it is described, for instance, in the prior application 100 36 610.4.

The conductor 1a or 2a is a multi-wire strand as it is shown in FIG. 2.

The strand 1a, 2a consists of seven wire bundles 4, six of which are stranded as a layer around a central wire bundle. Each wire bundle 4 has an inner core wire 5 around which six individual wires 7 are stranded. These individual wires 7 are preferably stranded with an alternating direction of lay-which in cable technology is referred to as SZ-stranding.

The core wire 5 is made of a material with high tensile strength and alternating bending strength. Preferably, a chromium-nickel steel with a strength of 1770 N/mm² is used.

The individual wires 7 are copper wires having a strength of approximately 280 N/mm².

A conductor depicted in FIG. 2 can be produced in a single process step. First, the wire bundles 4 comprising a core wire 5 and the copper wires 6 are produced by means of seven SZ-stranding devices.

The seven wire bundles 4 are then guided through a stranding die and wound onto a rotating winding reel. Due to the rotations of the winding reel, the wire bundles 4 are stranded together to form the multi-wire conductor 1a, 2a.

Electrical cables according to the teaching of the invention may be used in the automotive industry, in medical technology as well as in compression-type refrigerators.

Typical dimensions of a cable according to the invention are:

| | | |
|---|---|---|
| Core wire diameter | 0.12 | mm |
| Copper wire diameter | 0.11 | mm |
| Length of lay | 4.0 | mm |
| Length of lay of wire bundles | 11.8 | mm |
| Outside diameter of conductor | 1.02 | mm |
| Production rate | 30 | m/min |

What is claimed is:

1. An electrical cable with an electrical conductor (1a, 2a) and an insulating layer (1b, 2b ) surrounding said conductor, characterized in that the conductor (1a, 2a) comprises a plurality of stranded or bunched wire bundles (4) and each wire bundle (4) comprises a central core wire (5) made of a metal with high tensile strength and alternating bending strength and a plurality of copper wires (6) stranded around said core wire (5).

2. An electrical cable as claimed in claim 1, characterized in that the core wire (5) is made of a steel having a strength of at least 1500 N/mm².

3. An electrical cable as claimed in claim 2, characterized in that the core wire (5) is made of a chromium-nickel steel having a strength of more than 1700 N/mm².

4. An electrical cable as claimed claim 1, characterized in that the copper wires (6) are stranded onto the core wire (5) with alternating direction of lay.

5. An electrical cable as claimed in Claim 1, characterized in that each wire bundle (4) comprises a central core wire (5) and six copper wires (6) stranded around said core wire.

6. An electrical cable as claimed in claim 1, characterized in that a layer of six wire bundles (4) is stranded around a centrally disposed wire bundle (4).

7. An electrical cable as claimed in claim 1, characterized in that the entire conductor is constructed of seven or nineteen elements, wherein each element comprises a centrally disposed wire bundle and a layer of six wire bundles stranded onto said central wire bundle.

8. An electrical cable as claimed in claim 1, characterized in that it comprises one or more insulated conductors (1, 2).
